(19) United States
(12) Patent Application Publication
(10) Pub. No.: US 2018/0165420 A1
(43) Pub. Date: Jun. 14, 2018

(54) Systems for Radionuclide Production

(71) Applicant: Siemens Medical Solutions USA, Inc., Malvern, PA (US)

(72) Inventor: Alexis Motto, Princeton, NJ (US)

(21) Appl. No.: 15/378,253

(22) Filed: Dec. 14, 2016

(51) Int. Cl. G06F 19/00; G06F 17/12

(52) U.S. Cl. CPC G06F 19/3456; G06F 17/12

(57) ABSTRACT

A system comprises determination of an objective function representing costs of creating doses of a positron emission tomography radioactive tracer and delivering the doses to customers, the objective function being subject to production constraints associated with one or more cyclotrons, delivery constraints and customer constraints, where the production constraints, delivery constraints and customer constraints are defined by discrete variables, continuous variables and parameter values, reception of a set of parameter values, generation of a solution to the objective function based on received set of parameter values to determine values of the discrete variables and the continuous variables which correspond to suitable costs of creating the doses and delivering the doses to customers, and generation of a positron emission tomography radioactive tracer production plan and a delivery schedule based on the values of the discrete variables and the continuous variables.

### BACKGROUND

Nuclear medicine imaging uses low-level radioactive compounds, or radionuclides, to generate images of internal patient volumes. Specifically, radionuclides are introduced into a patient and absorbed by organs, bones or tissues. A scanner detects gamma rays emitted by the absorbed radionuclides and an image is generated based on the detected gamma rays.

Radionuclides doses are typically produced by a radiopharmacy and delivered to customers (e.g., a nuclear medicine imaging center) according to pre-defined customer contract terms. Currently, a delivery optimizer determines a delivery schedule for all doses based on known delivery parameters, and on contracted radioactivity and ready-times of dose batches and of the individual patient doses allocated to each batch. Outputs from the delivery optimizer allow modelling of different production scenarios and dose allocation schemes to determine the impact on the delivery schedule and the total cost of delivery.

The foregoing production process is unsuitably inefficient and there is thus a need for systems providing improved integration of radionuclide production and delivery.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 illustrates a system according to some embodiments;

FIG. 2 illustrates a radionuclide production process according to some embodiments;

FIG. 3 is a flow diagram of a process according to some embodiments;

FIG. 4 is a functional block diagram of a system according to some embodiments;

FIG. 5 is a flow diagram of a process according to some embodiments;

FIG. 6 is a functional block diagram of a system according to some embodiments; and

FIG. 7 is a block diagram of a computing system according to some embodiments.

### DETAILED DESCRIPTION

The following description is provided to enable any person in the art to make and use the described embodiments and sets forth the best mode contemplated for carrying out the described embodiments. Various modifications, however, will remain readily apparent to those in the art.

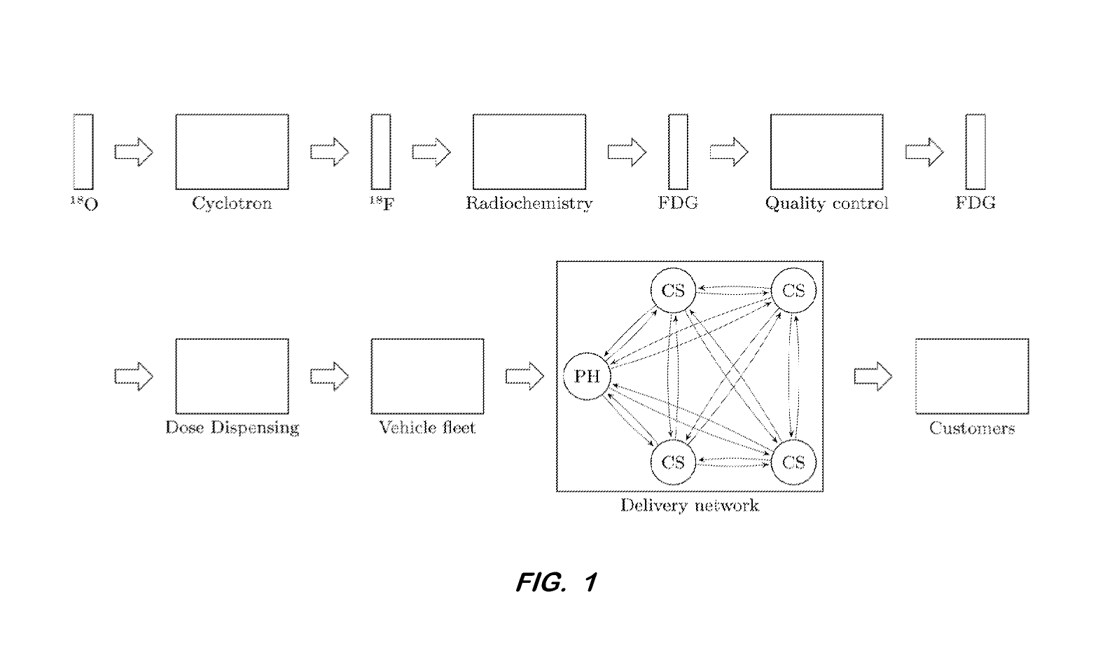

FIG. 1 illustrates the production and delivery of radionuclides according to some embodiments. Production is governed by a production plan and delivery is governed by delivery schedules. A production plan is a collection of doses that are allocated to a specific batch of products. An individual batch may provide sufficient product for up to a finite number of individual doses. The number of doses from each batch depends on customer locations and customer ordering patterns. The number of doses allocated to a batch also depends on the batch size, which in turn is governed by the amount of radioactivity produced by the available cyclotrons, the efficiency of synthesis and the quality control process.

A delivery schedule is a collection of doses that are assigned to delivery vehicles and routed to customer locations. Delivery schedules are site-specific and based on geography and local customer requirements. Delivery schedules may vary depending on the day of the week and/or on seasonal ordering patterns. In addition, delivery schedules may require last-minute changes to accommodate patient change orders (i.e., new orders, cancellations, or modification of previous orders). Other constraints associated with delivery schedules include the number of available delivery vehicles, the capacity of each delivery vehicle, etc.

According to some embodiments, a batch optimizer allocates individual doses to batches in order to most-efficiently utilize each batch. The batch optimizer simultaneously minimizes costs associated with batch production as well as costs associated with dose delivery. The starting points for the batch optimizer are a user-defined series of batches and a collection of individual patient doses for each batch that have been manually assigned to each batch by the user. The output of the batch optimizer is the same as the output of the aforementioned delivery optimizer and also includes the optimized dose allocations to each batch, along with the ability for the user to accept the optimized allocations.

Some embodiments provide a multi-stage stochastic programming model, for optimization of a radionuclides supply chain, which supports model uncertainties, soft operational constraints and hard physical constraints on decision variables, and approximation of the nonlinear model into a mixed-integer linear model for which open-source and commercial solvers exist. The models are written in a manner that exhibits their sparse structure, which can be exploited to decrease its computational complexity and memory footprint.

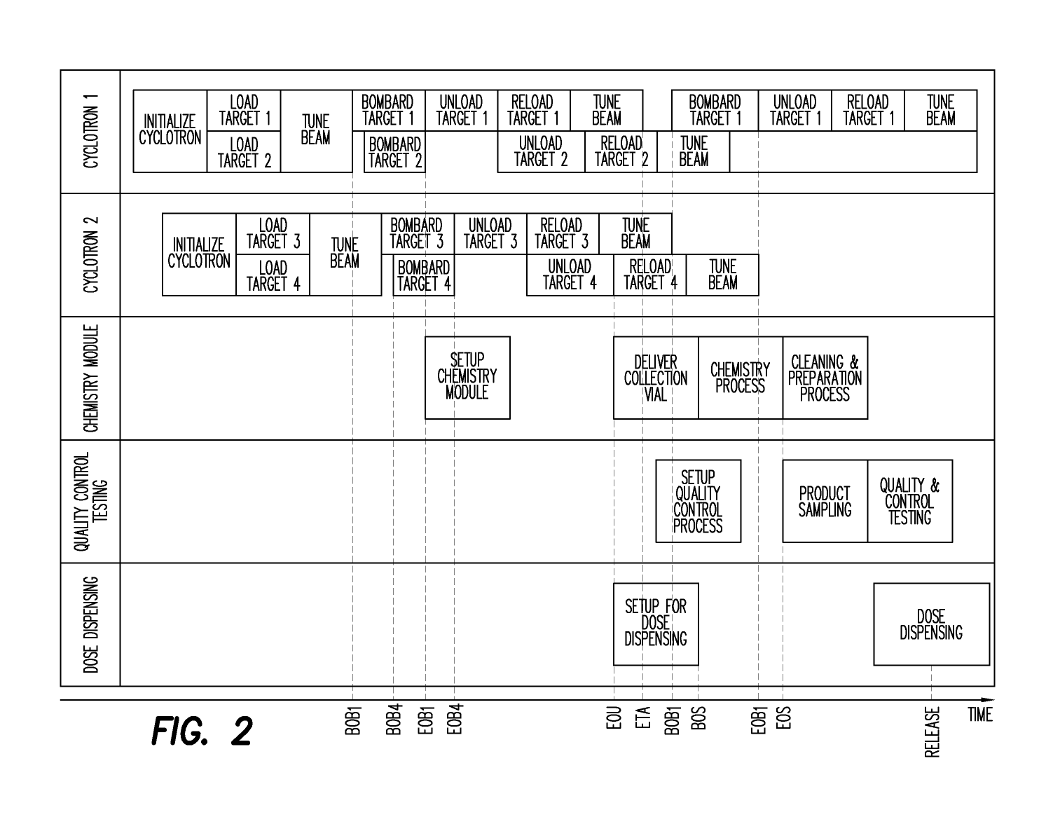

FIG. 2 illustrates a production process of a radiopharmacy or other vendor of radionuclides. The production process represents the functional blocks shown in FIG. 1 from cyclotron through dose dispensing. Prior to a discussion of FIG. 2, the acronyms, parameters, continuous variables and discrete variables discussed herein will be defined.

### Acronyms

BG Batch group
BH Batch
BOB Beginning of bombardment
BOS Beginning of synthesis
BR Branch
CM Customer
CS Case
CY Cyclotron
DS Dose
EOB End of bombardment
EOU End of unload
ETA Earliest time target is available
MD Multi-dose vial
MS Manufacturing site
ND Node
PET Positron emission tomography
PH Pharmacy
QC Quality control
RN Radionuclide
SY System
TN Time
TR Trip
UD Unit-dose syringe
VH Vehicle

### Parameters

π_{Dllω}_{ₖ}^{BR} Traveling distance between origin and destination nodes of branch l.
π_{DUlω}_{ₖ}^{BR} Travel duration between origin and destination nodes of branch l.
π_{NDcω}_{ₖ}^{CS} Maximum number of unit-dose syringes in case c;
π_{MKuω}_{ₖ}^{VH} Mileage rate contracted with vehicle c;
π_{MAcω}_{ₖ}^{CM} Maximum radioactivity allowed at customer site c;
π_{SCcω}_{ₖ}^{CM} Startup cost of cyclotron c;
π_{ETdω}_{ₖ}^{CY} Earliest time to deliver dose d;
π_{LAdω}_{ₖ}^{DS} Injection radioactivity of dose d;
π_{ITdω}_{ₖ}^{DS} Injection time of dose d;
π_{LTdω}_{ₖ}^{DS} Latest time to deliver dose d;
π_{SFnω}_{ₖ}^{ND} Stop fee at site n;
π_{DRrω}_{ₖ}^{RN} Decay rate of radionuclide r;
π_{DT107} _{ₖ}^{SY} Discrete time step;
π_{FSω}_{ₖ}^{SY} Fuel surcharge;
π_{IVω}_{ₖ}^{SY} Maximum number of (internal) vehicles;
π_{QCω}_{ₖ}^{SY} Time required to complete the quality control;
π_{DTtω}_{ₖ}^{TG} Minimum down-time of target t;
π_{Ttω}_{ₖ}^{TG} Minimum (or lower) bombardment time of target t;
π_{SYtω}_{ₖ}^{TG} Saturation yield for target t;
π_{UBtω}_{ₖ}^{TG} Maximum (or upper) bombardment time of target t;
π_{VCtω}_{ₖ}^{TG} Variable cost function of target t for cyclotron c;
π_{ENrω}_{ₖ}^{RN} Enrichment of radionuclide r;
   Continuous variables
x_{RAbkω}_{ₖ}^{BH} Radioactivity of batch b at time k;
x_{ESbω}_{ₖ}^{BH} of batch h;
x_{RAcω}_{ₖ} Radioactivity of cyclotron c at time k;
x_{DTdω}_{ₖ}^{DS} Delivery time of dose d;
x_{UAdω}_{ₖ}^{DS} Radioactivity of dose d at EOB;
x_{ETdω}_{ₖ}^{DS} End of bombardment (EOB) time of dose d;
x_{RTdω}_{ₖ}^{DS} Ready-time of dose d;
x_{RAtkω}_{ₖ}^{TG} Radioactivity of target t at time k;
x_{BCtkω}_{ₖ}^{TG} Beam current applied to target at time k;
x_{OFtkω}_{ₖ}^{TG} Number of time increments that target t has been off-bombardment at the end of time k;
x_{ONtkω}_{ₖ}^{TG} Number of time increments that target t has been on-bombardment at the end of time k;
x_{CTtω}_{ₖ}^{TR} Completion time of trip t;
x_{DUtω}_{ₖ}^{TR} Duration of trip t;

### Discrete Variables

y_{VHcrω}_{ₖ}^{CS} Equal to 1 if case c is assigned to trip t, or 0, otherwise;
y_{ONtkω}_{ₖ}^{CY} Equal to 1 if cyclotron c is online at time k, or 0, otherwise;
y_{SDthω}_{ₖ}^{CY} Equal to 1 if cyclotron c is shutdown at time k, or 0, otherwise;
y_{STthω}_{ₖ}^{CY} Equal to 1 if cyclotron c is started at time k, or 0, otherwise;
y_{CAdcω}_{ₖ}^{DS} Equal to 1 if dose d is assigned to case c, or 0, otherwise;
y_{CYdcω}_{ₖ}^{DS} Equal to 1 if doseis assitn to cyclotron c, or 0,otherwise;
y_{BTdkω}_{ₖ}^{DS} Equal to 1 if EOB of dose d is at time k, or 0, otherwise;
y_{JVkω}_{ₖ}^{SY} Equal to 1 if all internal vehicles are assigned to trips at time k, or 0, otherwise; at the beginning of time k;
y_{ETtkω}_{ₖ}^{TG} Equal to 1 it bombardment ended on target t at the beginning of time k, or 0, otherwise;
y_{ONtkω}_{ₖ}^{TG} Equal to 1 if target t is online at time k, or 0, otherwise;
y_{SDtkω}_{ₖ}^{TG} Equal to 1 if target t is shutdown at time k, or 0, otherwise;
y_{STtkω}_{ₖ}^{TG} Equal to 1 if bombardment started on target t at the beginning of time k, or 0, otherwise;
y_{ANtnkω}_{ₖ}^{TR} Equal to 1 if trip t arrives at node n at time k, or 0, otherwise;
y_{BNtnkω}_{ₖ}^{TR} Equal to 1 if trip t arrives at node n by time k, or 0, otherwise;
y_{BRtlω}_{ₖ}^{TR} Equal to 1 if trip t traverses delivery branch [symbol] or 0, otherwise;
y_{VHtvω}_{ₖ}^{TR} Equal to 1 if trip t is assigned to vehicle d, or 0, otherwise;
y_{NDtnω}_{ₖ}^{TR} Equal to 1 if trip t stops at node n, or 0, otherwise;

Also, regarding the notation used below, if x is a variable, then x and x̅ denote its lower limit and upper limit, respectively. If XY denotes the two-letter mnemonic of some object class, then [symbol] ^{XY} denotes the index set of the corresponding objects. For example, ND is the two-letter mnemonic for the class of nodes, and [symbol] ^{ND} denotes the index set of nodes. If [symbol] denotes some edge of the delivery network, then o( [symbol] ) and d( [symbol] ) denote the origin node and destination node, respectively, of [symbol] . If t denotes a trip, then o(t) and d(t) denote the origin node and destination node, respectively, of t. The symbol Iₖ^{CM} denotes the index set of fixed customer sites (i.e. k=1), and mobile customer sites (i.e. k=2). The symbol I_{tc}^{TR} denotes the index set of allowed times for trip t to arrive at customer site c. The symbol Iₖ^{VH} denotes the index set of internal vehicles (i.e. k=1), and external vehicles (i.e. k=2). The symbol Iₖ^{DS} denotes the set of unit-dose syringes (i.e. k=2) and multi-dose vials (i.e. k=2). Other symbols with a narrower scope are defined below.

Returning to FIG. 2, the radioactivity of a radionuclide at time t, qₜ, is modelled by the following first order differential equation:

dqₜ=−λqₜdt, (1)

where λ denotes the decay constant of the radionuclide, respectively.

From (1), we can determine the radioactivity lost to radioactive decay over a time interval. For example, based on the radioactivity in a unit dose syringe q_{INJ} at the time of injection t_{INJ}, the radioactivity at the end of synthesis q_{EOS} is:

q_{INJ}=g_{EOS}exp(−λ(t_{INJ}−t_{EOS})) (2)

From (2), we derive q_{EOS} as follows:

q_{EOS}=q_{INJ}e^{λ(t}^{_{INJ}}^{-t}^{_{EOS}}⁾. (3)

Cyclotron Process

A cyclotron is a type of particle accelerator; i.e. a device that utilizes electromagnetic fields to propel charged particles to high speeds and to contain them in well-defined beams. As depicted in FIG. 1, a cyclotron produces target radionuclides or radioisotopes (e.g., ¹⁸F-fluoride ion) by proton bombardment of a target containing a raw material (e.g., ¹⁸O-water). After unloading bombarded targets from a cyclotron, the targets are chemically synthesized with organic molecules (e.g., glucose) to form a batch of radiopharmaceutical or radioactive tracer (e.g., 18F-FDG radioactive tracer). The uptake of 18F-FDG by tissues is a marker for the tissue uptake of glucose, which in turn is closely correlated with certain types of tissue metabolism. After 18F-FDG is injected into a patient, a PET scanner can form two-dimensional or three-dimensional images of the distribution of 18F-FDG within the body.

A manufacturing facility may include one or more cyclotrons. Each cyclotron generates two beam lines, so a cyclotron may bombard one or more targets. Thus, it is possible to use any combination of targets to produce a single product batch. However, if a cyclotron performs a dual bombardment, the targets must be on different beamlines. It is not possible to simultaneously bombard two targets on the same beamline.

The target loading process of FIG. 2 must be completed before applying beam to the target. If two targets are used in the bombardment process, the target loading process must be completed for both targets before applying the beam to either target. Targets may be simultaneously loaded with ¹⁸O-water. When first applying the beam to a target, a tuning process is required before the beam can be operated at full power. The beginning of bombardment (BOB) occurs after the beam is at full power on the target. If two targets are used in the bombardment process, the BOB may be different for each target. The radioactivity of ¹⁸O-water and the time required to load the ¹⁸O-water may differ for each target.

The beam current is a measure of the proton flux on a target and may range from 10 μA to 80 μA. The end of bombardment (EOB) occurs when the beam current is set to zero. If two targets are used in the bombardment process, the EOB will be the same for both targets. The bombardment time is the length of time between the BOB and the EOB. The bombardment time may range from 5 minutes to 4 hours. The saturation yield of a target represents the theoretical maximum amount of ¹⁸F-fluoride ion that may be produced by a target. The saturation yield depends on the beam energy of the cyclotron and may range from 70 mCiμA⁻¹ to 260 mCiμA⁻¹.

The radioactivity of ¹⁸F-fluoride ion produced in a target is given by:

q_{F}=i_{BC} α_{SY} EN·(1−e^{-λt}^{_{BOMB}}) (4)

q_{Ftω}_{ₖ}^{TG}=i_{BCtω}_{ₖ}^{TG}π_{SYtω}_{ₖ}^{TG}π_{ENrω}_{ₖ}^{RN}(1−e^{-λt}^{_{BOMBtωk}}^{^{TG}}) (5)

where q_{F} denotes the radioactivity of ¹⁸F-fluoride ion, i_{BC} denotes the beam current, α_{SY} denotes saturation yield for the target, EN denotes the enrichment of the ¹⁸O-water and t_{BOMB} denotes the bombardment time.

The bombardment time, the beam current, the ¹⁸O-water enrichment and the saturation yield may be different for each target. The bombardment time and beam current may be adjusted on a batch-to-batch basis in order to produce the required radioactivity of ¹⁸F-fluoride ion. The saturation yield of a target does not change on a batch-to-batch basis.

The cost of materials in a batch due to the ¹⁸O-water increases with the radioactivity of ¹⁸O-water used in the target and the number of targets used in the bombardment. The cost due to ¹⁸O-water also depends on the enrichment. The cost of materials is not affected by beam current, bombardment time, or the saturation yield. The cost of labor increases with the bombardment time due to indirect labor costs.

According to some embodiments, a batch optimizer component determines the number of targets, the beam current, the BOB and the bombardment time for each target used in a batch.

Target Unload Process

The ¹⁸F-fluoride ion produced by each target is consolidated into a single solution during the unload process of FIG. 2. To accomplish this, each target is sequentially unloaded to a collection vial (i.e., a v-vial). Targets may not be unloaded simultaneously. The unload time may be different for each target. The time at which the last target unload is complete is defined as the end of unload (EOU). After the unload for the last target is complete, the total ¹⁸F-fluoride ion is given by:

q_{FTOTAL}=q_{F1}+q_{F2}e^{-λt}^{_{F2}}+q_{F3}e^{-λt}^{_{F3}}+q_{F4}e^{-λt}^{_{F4}} (6)

where q_{FTOTAL} denotes the total radioactivity of ¹⁸F-fluoride ion decay corrected to the EOU, q_{F1} denotes the radioactivity of ¹⁸F-fluoride ion produced in the last target unload, q_{F2}, q_{F3}, q_{F4} represent the radioactivity of ¹⁸F-fluoride ion at the end of earlier target unloads, and t_{F2}, t_{F3}, t_{F4} represent the time interval between an earlier target unload and the EOU.

Target Reload Process in Preparation for Another Bombardment

After completing the unload process, a target may be immediately reloaded in preparation for another bombardment. The time required for the reload process is the same as the time for the original target load process. After the target is reloaded, the beam may be started on the target and the next BOB will occur after the beam tuning process. This represents the earliest time the target is available (ETA) for the next BOB. In the case of a dual bombardment, the next BOB for both targets is the latest time that either target is available. The beam may be started as soon as the targets for the next batch have been reloaded.

¹⁸F-Fluoride Ion Transfer Process

After the target unload process is complete, the solution of ¹⁸F-fluoride ion in the collection vial is transferred to the chemistry module. Regardless of the number of targets, there is only one transfer process for each batch of product. A small percentage of the total ¹⁸F-fluoride ion is lost during the transfer process. The time when the ¹⁸F-fluoride ion transfer process is complete is defined as the beginning of synthesis (BOS). The radioactivity of ¹⁸F-fluoride ion at the BOS is given by:

q_{BOS}=q_{FTOTAL}(1−nα)e^{-λt}^{_{TRAN}} (7)

where q_{BOS} denotes the radioactivity of ¹⁸F-fluoride ion at the BOS, n denotes the number of targets, α is the fractional percentage lost during the unload process, and t_{TRAN} is the time interval between completing the target unload process and the BOS.

The fractional percentage of radioactivity lost and the transfer time may be generalized as the same for all targets at a manufacturing facility.

Chemistry Module

A manufacturing facility may have one or more chemistry modules. A chemistry module may be capable of making up to four batches of product. For chemistry modules with this capability, the module may only produce batches sequentially (i.e., it is not possible for a chemistry module to simultaneously prepare more than one batch of product).

After the ¹⁸F-fluoride ion transfer process is complete, a chemistry module converts the available ¹⁸F-fluoride ion into the PET drug of interest. A percentage of the ¹⁸F-fluoride ion is lost during the chemistry process. This percentage is known as the percent yield of the chemistry process. The time at which the chemistry process is complete is referred to as the end of synthesis (EOS). The radioactivity of the product at the EOS is given by:

q_{EOS}=q_{BOS}PYe^{-λt}^{_{CHEM}} (8)

where q_{EOS} denotes the radioactivity of product at the EOS, PY denotes the percent yield of the process, and t_{CHEM} is time interval between the EOS and the BOS (i.e., the synthesis time).

Each PET drug product has a unique percent yield and synthesis time. The percent yield and synthesis time may vary at each manufacturing facility. The percent yield and synthesis time are constant for each batch of product at a manufacturing facility. The cost of materials and labor for the chemistry process includes the costs associated with production and QC testing. Materials and labor costs are constant for each batch, but are different for each product.

Cleaning and Preparation for Another Batch

A chemistry module is associated with a clean time that defines the ETA until the module may be used again for another batch of product. The clean time may also include a time period required for radioactive decay of residual radioactivity to allow manual intervention in preparation for the next batch. After expiration of the clean time, a chemistry module may be used in preparation of another batch of product. This cleaning/preparation time may be unique for each product at a manufacturing facility.

Quality Control Testing

After the chemistry process is complete, the product is sampled for purposes of quality control (QC) testing. This sample is a percentage of the product resulting from the chemistry process. The remaining radioactivity of the product is available for dose dispensing. The radioactivity of product available for dose dispensing, decay corrected to the EOS, is given by:

q_{DISP}=(1−β)q_{EOS} (9)

where q_{DISP} denotes the radioactivity of product available for dose dispensing, and β denotes the percentage of the product used in the sample.

Each PET drug has a unique sample percentage and sampling time. The sample percentage and the sampling time may vary at each manufacturing facility. The sample percentage and the sampling time are constant for each batch of product at a manufacturing facility.

After the sample has been removed from the product, the QC process is performed and the dose dispensing process may begin on the remaining product, q_{DISP}. Each PET drug has a unique QC process time. The QC process time may vary at each manufacturing facility. The QC process time is constant for each batch of product at a manufacturing facility.

Dose Dispensing

The dose dispensing process may be executed simultaneously with the QC process. The dispensed doses may not be released from the manufacturing facility until after the QC process is complete and the batch meets all QC release criteria. The dose dispensing process may be used to prepare either multi-dose vials or unit-dose syringes for distribution. The aggregate, decay-corrected radioactivity of all dispensed doses cannot exceed q_{DISP}. This relationship is given by:

q_{DISP}≥Σq_{DOSE}e^{-λ(t}^{_{DOSE}}⁾ (10)

where q_{DOSE} denotes the radioactivity of product in an individual dose at the injection time, t_{DOSE} is the time interval between the injection time and the EOS, and the summation is over all doses assigned to the batch.

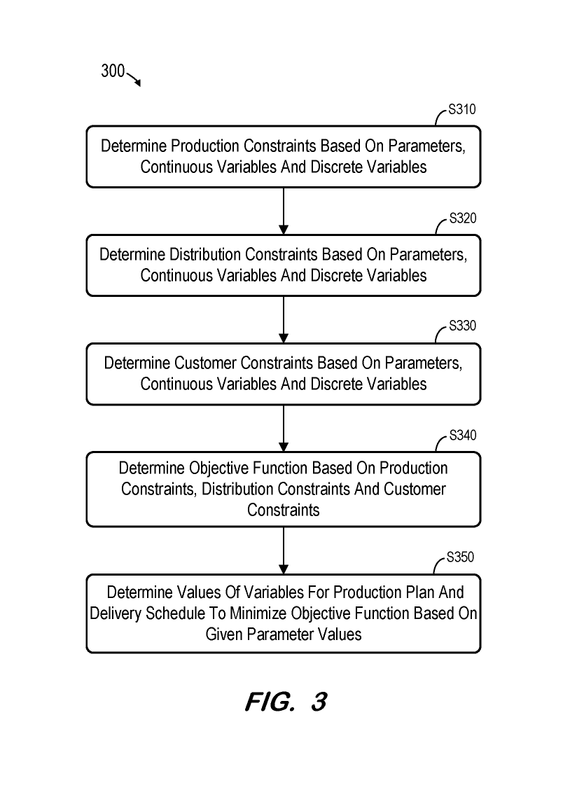

FIG. 3 comprises a flow diagram of process 300 according to some embodiments. Process 300 may be executed to determine a production plan and a delivery schedule for radionuclides according to some embodiments. Process 300 and the other processes described herein may be performed using any suitable combination of hardware, software or manual means. Software embodying these processes may be stored by any non-transitory tangible medium, including a fixed disk, a floppy disk, a CD, a DVD, a Flash drive, or a magnetic tape.

Production constraints are initially determined at S310. According to some embodiments, the production constraints are determined based on parameters, continuous variables and discrete variables as listed above. Production constraints may be modeled to support various products, each of which has a unique half-life, manufacturing cost and manufacturing time (e.g., FDG, Amyvid, NaF, NH4, FLT, and Lantheus). According to some embodiments, production constraints may include cyclotron contraints, chemistry block constraints, quality control block constraints, and dose dispensing constraints.

Cyclotron Constraints

Production constraints may include constraints directly related to the cyclotron(s) used to bombard the target(s). The number of targets produced per run determines the output and cost of a batch. A cyclotron has fixed minimum-up and minimum-down times, so the output radioactivity of a product depends on the duration of bombardment (i.e., the time interval between EOB and SOB).

Production constraints (11) below model the minimum-up time and minimum-down time constraints of a cyclotron. Constraint (11a) defines the number of time increments that a cyclotron t has been on-line at the end of time interval k. Constraint (11b) defines the number of time increments that a cyclotron t has been off-line at the end of time interval k. By definition, x_{ONtkω}_{ₖ}^{TG} is a non-negative integer and x_{OFtkω}_{ₖ}^{TG} is a non-positive integer. Thus, the minimum down-time is the absolute value of x_{OFtkω}_{ₖ}^{TG}. Constraint (12a) defines the radioactivity of a target from SOB, and constraint (12b) enforces that the radioactivity produced by a cyclotron is the sum of radioactivity of the associated targets.

x_{ONtkω}_{ₖ}^{TG}=(y_{ONt(k-1)ω}_{ₖ}^{TG}−y_{SDt(k-1)ω}_{ₖ}^{TG})x_{ONt(k-1)ω}_{ₖ}^{TG}+y_{ONtkω}_{ₖ}^{TG}, ∀t ∈ [symbol] ^{TG}, ∀k ∈ [symbol] ^{TM}, ∀ω ∈ [symbol] ^{SC}, (11a)

x_{OFtkω}_{ₖ}^{TG}=(1−y_{ONt(k-1)ω}_{ₖ}^{TG}−y_{STt(k-1)ω}_{ₖ}^{TG})x_{OFt(k-1)ω}_{ₖ}^{TG}+y_{ONtkω}_{ₖ}^{TG}−1, ∀t ∈ [symbol] ^{TG}, ∀k ∈ [symbol] ^{TM}, (11b)

(x_{ONt(k-1)ω}_{ₖ}^{TG}−π_{UTtω}_{ₖ}^{TG})(y_{ONt(k-1)ω}_{ₖ}^{TG}−y_{ONtkω}_{ₖ}^{TG})≥0, ∀t ∈ [symbol] ^{TG}, ∀k ∈ [symbol] ^{TM}, (11c)

(x_{OFt(k-1)ω}_{ₖ}^{TG}−π_{DTtω}_{ₖ}^{TG})(y_{ONt(k-1)ω}_{ₖ}^{TG}−y_{ONtkω}_{ₖ}^{TG})≤0, ∀t ∈ [symbol] ^{TG}, ∀k ∈ [symbol] ^{TM}, (11d)

y_{STtkω}_{ₖ}^{TG}−y_{SDtkω}_{ₖ}^{TG}=y_{ONtkω}_{ₖ}^{TG}−y_{ONt(k-1)ω}_{ₖ}^{TG}, ∀t ∈ [symbol] ^{TG}, ∀k ∈ [symbol] ^{TM}, (11e)

y_{STtkω}_{ₖ}^{TG}+y_{SDtkω}_{ₖ}^{TG}≤1, ∀t ∈ [symbol] ^{TG}, ∀k ∈ [symbol] ^{TM}, (11f)

x_{RAtkω}_{ₖ}^{TG}−x_{BCtkω}_{ₖ}^{TG}π_{SYtω}_{ₖ}π_{ENr(t)ω}_{ₖ}^{RN}[1−exp(−π_{DRr(t)ω}_{ₖ}^{RN}π_{DTω}_{ₖ}^{SY}x_{ONtkω}_{ₖ}^{TG})]+x_{Bt(k-x}_{_{OFtkωk}}_{^{TG}}₎[exp(π_{DRr(t)ω}_{ₖ}^{RN}π_{DTω}_{ₖ}^{SY}x_{OFtkω}_{ₖ}^{TG})−y_{ONtω}_{ₖ}^{TG}].

∀t ∈ [symbol] ^{TG}, ∀k ∈ [symbol] ^{TM}. (12a)

x_{RAckω}_{ₖ}^{CY}= [symbol] x_{RAtkω}_{ₖ}^{TG}, ∀c ∈ [symbol] ^{CY}, (12b)

x_{RAtkω}_{ₖ}^{TG}=x_{OFtkω}_{ₖ}^{TG}y_{ONtkω}_{ₖ}^{TG}+x_{OFtkω}_{ₖ}^{TG}y_{ONtkω}_{ₖ}^{TG} (13a)

The following constraints, equivalent to (12a), may be used to compute x_{RAtkω}_{ₖ}^{TG} recursively, where the auxiliary variable \tilde{x}_{tkω}_{ₖ}^{TG} denotes the value of the decay function at time k:

\tilde{x}_{tkω}_{ₖ}^{TG}=\tilde{x}_{t(k-l)ω}_{ₖ}^{TG}exp(−π_{DRr(t)ω}_{ₖ}^{RN}π_{DTω}_{ₖ}^{SY})(1−y_{STtk}_{_{ω}}_{ₖ}^{TG})+y_{STtkω}_{ₖ}^{TG} (14a)

x_{RAtkω}_{ₖ}^{TG}=x_{BCtkω}_{ₖ}^{TG}π_{SYtω}_{ₖ}^{TG}π_{ENr(t)ω}_{ₖ}^{RN}(1−\tilde{x}_{tkω}_{ₖ}^{TG})y_{ONtkω}_{ₖ}^{TG}+(1−y_{ONtkω}_{ₖ}^{TG})\tilde{x}_{tkω}_{ₖ}^{TG} (14b)

Chemistry Block Constraints

As described above, a chemistry block synthesizes one product batch from the cyclotron-produced targets. A batch is therefore a collection of targets. Constraint (15a) below determines the radioactivity of a batch as the sum of activities over all combined targets. Constraint (15b) ensures that the total radioactivity at a manufacturing site may not exceed a standard threshold. The number of chemistry boxes is site-dependent and product-dependent. A chemistry unit has a minimum duty-cycle, and the cost of chemistry is always constant per product. The time needed to complete chemistry is constant per product. The production plan may include a recommended radioactivity at EOS of each produced batch.

x_{RAbkω}_{ₖ}^{BH}= [symbol] x_{RAtkω}_{ₖ}^{TG}, ∀c ∈ [symbol] ^{CY}, ∀b ∈ [symbol] ^{BH}, ∀k ∈ [symbol] ^{TM} (15a)

[symbol]

x_{RAbkω}_{ₖ}^{BH}≤x̅_{1g}^{BG}, ∀g ∈ [symbol] ^{BG}, ∀k ∈ [symbol] ^{TM}, (15b)

Quality Control Block Constraints

The quality control block tests the radionuclide product, as well as the raw materials and supplies used in the production of the product. The quality control block subtracts a fraction, say β, of the radioactivity from a synthesized batch. For notational symplicity, from here onward, we write x_{RAbkω}_{ₖ}^{BH} for (1−β) x_{RAbkω}_{ₖ}^{BH}. (3)

Dose Dispensing

Batches that successfully pass the quality control tests are dispensed into customer-ordered multi-dose vials or unit-dose syringes for distribution. The aggregate radioactivity over all unit dose syringes and all multi-dose vials dispensed from a given batch is less than the radioactivity of the batch. Constraint (16c) ensures that EOB time of a unit dose syringe u coincides with one EOB time of the assigned cyclotron c(u). Constraint (16d) determines the EOB time of each dose, and constraint (16b) ensures that each dose is assigned to one batch.

x_{RAbω}_{ₖ}^{BH}≥ [symbol] x_{ETuω}_{ₖ}^{DS}, ∀b ∈ [symbol] ^{BH}, (16a)

[symbol]

y_{CYdbω}_{ₖ}^{DS}=1, ∀d ∈ [symbol] ^{DS}, (16b)

y_{SDt(d)kω}_{ₖ}^{TG}≥y_{ETdkω}_{ₖ}^{DS}, ∀d ∈ [symbol] ^{DS}, ∀k ∈ [symbol] ^{TM}, (16c)

x_{ETdω}_{ₖ}^{DS}= [symbol] y_{ETdkω}_{ₖ}^{DS}k, ∀d ∈ [symbol] ^{DS}, (16d)

Returning to process 300, distribution constraints are determined at S320 after determination of the production constraints at S310. The determined distribution constraints may also be based on parameters, continuous variables and discrete variables.

Distribution constraints according to some embodiments account for two classes of couriers: external couriers (e.g., UPS, BDS, Carefree, and MDS) and internal couriers. By contract, each courier may service a given set of pharmacy and customer locations. A vehicle will be associated with a route and delivery to a specified number of customer locations. Each vehicle has a maximum weight capacity. Maximum time from EOS to injection time is 11 hours (e.g., for FDG). The times will vary based on product. Each vehicle is allowed to carry a maximum level of radioactivity in each route (i.e., according to its radioactive material (RAM) license). Since the radioactivity decreases while enroute due to radioactive decay, this maximum level is compared with the total of the radioactivity of each container at the beginning of the route (i.e., at the production facility).

The constraints may utilize an average (i.e., average pigs per case) to determine the number of shipped cases. The cases should arrive 15 to 60 minutes before injection time (the actual time may differ from contract to contract). The model shall recommend the packing of each route based on customer data, the ready time of each shipment, and the delivery time of each shipment. In the case of some pharmacies, it is necessary for the vehicle to return to the pharmacy to drop off empty cases and return keys. The vehicle may need to arrive earlier in a customer location (e.g., to clear specific security requirements). Depending on the location this early arrival may vary between 0-X minutes, and is taken into consideration in calculation of the radioactivity, optimal routes and delivery times. Some embodiments further determine delivery constraints related to air freight.

Constraints (17) below enforce route consistency, for all i ∈ [symbol] ^{ND}.

$${\sum }_{l : o ( l ) = i} {y}_{BRtl {ω}_{k}}^{TR} - {\sum }_{l : d ( l ) = i} {y}_{BRtl {ω}_{k}}^{TR} = \{ \begin{matrix}1 , & if i = o ( t ) , & ( 17 a ) \\ - 1 , & if i = d ( t ) , & ( 17 b ) \\ 0 , & otherwise & ( 17 c )\end{matrix}$$

A route is not defined by the actual road segments traveled by a vehicle. In other words, a route may have more than one road segment options.

A delivery schedule is said to be non-preemptive if, once a vehicle starts a trip, the vehicle must complete the trip before starting another trip. A schedule is feasible only if it is non-preemptive and each vehicle is assigned to at most one trip at a time t.

Constraint (18a) ensures that each trip is assigned to at most one vehicle. Constraint (18b) ensures that the delivery schedule is non-preemptive. Constraints (18c) and (18d) ensure that an external vehicle is assigned to a trip only if no internal vehicle is available at time k. In other words, internal vehicles are preferred by requirement.

[symbol]

y_{VHtvω}_{ₖ}^{TR}≤1, ∀t ∈ [symbol] ^{TR}, (18a)

x_{CTjω}_{ₖ}^{TR}y_{DRtjdω}_{ₖ}≥x_{CTt}_{ₖ}_{ω}_{ₖ}y_{DRt}_{ₖ}_{dω}_{ₖ}+x_{DBt}_{ⱼ}_{ω}_{ₖ}y_{DRt}_{ⱼ}_{dω}_{ₖ}, or

x_{CTt}_{ₖ}_{ω}_{ₖ}y_{DRt}_{ₖ}_{dω}_{ₖ}≥x_{CTt}_{ⱼ}_{ω}_{ₖ}y_{DRt}_{ⱼ}_{dω}_{ₖ}+x_{DBt}_{ₖ}_{ω}_{ₖ}y_{DRt}_{ₖ}_{dω}_{ₖ},

∀tⱼ, tₖ ∈ [symbol] ^{TR}, tⱼ ≠ tₖ, ∀v ∈ [symbol] ^{VH}, (18b)

y_{IVkω}_{ₖ}^{SY}= [symbol] ^{TR}y_{VHtvω}_{ₖ}^{TR}, ∀t ∈ [symbol] ^{TR}, (18c)

y_{VHtvω}_{ₖ}≤y_{IVkω}_{ₖ}^{SY}, ∀t ∈ [symbol] ^{TR}, ∀v ∈ [symbol] ₂^{VH}, (18d)

y_{ANtnkω}_{ₖ}=y_{BNtnkω}_{ₖ}^{TR}−y_{BNtn(k-1)ω}_{ₖ}^{TR} (18e)

Next, at S330, customer constraints are determined based on parameters, continuous variables and discrete variables. There are two types of customers according to some embodiments: (i) fixed customers, and (ii) mobile customers. Let [symbol] ₁^{CM} and [symbol] ₂^{CM} denote the index sets of fixed and mobile, respectively, customers. The union of [symbol] ₁^{CM} and [symbol] ₂^{CM} is the index set of all customers, denoted [symbol] ^{CM}. A customer location is fixed at the time of dose ordering. A customer location is thus associated with one node in the supply chain network. Contractually, all customers must submit their dose orders by 5 PM for next-day delivery. In practice, customers may submit orders after 5 PM for next-day, or even same-day, delivery.

$$\begin{matrix}( 1 - {π}_{IV {ω}_{k}}^{SY} ) {π}_{IA d {ω}_{k}}^{DS} \leq {x}_{EA d {ω}_{k}}^{DS} exp [ - {π}_{DRr ( d ) {ω}_{k}}^{RN} {π}_{DT {ω}_{k}}^{SY} ( {π}_{ITd {ω}_{k}}^{DS} - {x}_{ETd {ω}_{k}}^{DS} ) ] \leq ( 1 + {π}_{1 Y {ω}_{k}}^{SY} ) {π}_{1 Ad {ω}_{k}}^{DS} , ∀ d ∈ {ℐ}^{DS} , & ( 19 a ) \\ {π}_{ETd {ω}_{k}}^{DS} \leq {x}_{DTd {ω}_{k}}^{DS} \leq {π}_{LTd {ω}_{k}}^{DS} , ∀ d ∈ {𝒥}^{DS} , & ( 19 b ) \\ {\sum }_{t ∈ {ℐ}^{TM} : t \leq k} [ u ( k - {x}_{DTd {ω}_{k}}^{DS} ) - u ( k - {π}_{ITd {ω}_{k}}^{DS} ) ] {x}_{EAd {ω}_{k}}^{DS} exp [ - {π}_{DRr ( d ) {ω}_{k}}^{RN} {π}_{DT {ω}_{k}}^{SY} ( k - {x}_{ETd {ω}_{k}}^{DS} ) ] \leq {π}_{MAc {ω}_{k}}^{CM} , ∀ c ∈ {ℐ}^{CM} , ∀ k ∈ {ℐ}^{TM} , & ( 19 c )\end{matrix}$$

where u denotes the Heaviside (or unit-step) function. Constraint (19a) ensures that the absolute difference between the optimized and ordered radioactivity at the ordered injection time of a dose does not exceed a standard threshold (e.g. 10%). Constraint (19b) enforces the earliest and latest dose delivery time requirement. Constraint (19c) ensures that the radioactivity of non-injected doses at a customer site does not exceed a threshold, as determined by the RAM license.

Doses are distributed in containers called cases. A case may contain 1, 2, or 3 doses. Some customers (e.g., imaging center personnel) prefer cases with 1 or 2 pigs, due to their lower weight and limits on the customer's staff. We shall assume the presence of an unlimited number of cases that will be used to deliver the doses to the customer locations.

[symbol]

y_{CAdcω}_{ₖ}^{DS}=1, ∀d ∈ [symbol] ^{DS}, (20a)

[symbol]

y_{CAdcω}_{ₖ}^{DS}≤π_{NDcω}_{ₖ}^{CS}, ∀c ∈ [symbol] ^{CS}, (20b)

[symbol]

y_{VHcvω}_{ₖ}^{CS}=1, ∀c ∈ [symbol] ^{CS}, (20c)

[symbol]

y_{VHcvω}_{ₖ}^{CS}≥y_{CAdcω}_{ₖ}^{DS}, ∀c ∈ [symbol] ^{CS}, (20d)

Constraint (20a) ensures that each dose is assigned to one case. Constraint (20b) enforces the maximum number of doses that a case may contain. Each multi-dose vial is packaged in a single case. Constraint (20d) ensures that each case is assigned to a trip.

Mobile customers use cases of similar weight that may however differ in shape. Although currently not the case, it is possible that some restriction on shape may be necessary. Mobile customers may be treated as fixed customers. Each mobile customer will be associated with a ship-to number based on the location at which they will receive orders.

An objective function is determined at S340 based on the determined production constraints, distribution constraints and customer constraints. The objective function is to minimize the expected total production and delivery costs. The delivery costs comprise stop fees, mileage costs, fuel surcharges, and toll way fees. The production costs encompass cyclotron setup costs and target costs. According to some embodiments, using the constraints determined as described above, an objective function is as follows:

$$z = 𝔼 \{ {\sum }_{υ ∈ {ℐ}^{VH}} {\sum }_{t ∈ {ℐ}^{TP}} {\sum }_{l ∈ {ℐ}^{BR}} {π}_{MRv {ω}_{k}}^{VH} {π}_{Dtl {ω}_{k}}^{BR} {y}_{BRtl {ω}_{k}}^{TR} + {\sum }_{c ∈ {ℐ}^{CM}} {\sum }_{t ∈ {ℐ}^{TP}} {\sum }_{n ∈ {ℐ}^{BR}} {π}_{SFn {ω}_{k}}^{ND} {y}_{NDtn {ω}_{k}}^{TR} + {\sum }_{k ∈ {ℐ}^{TM}} {\sum }_{c ∈ {ℐ}^{CY}} {\sum }_{t ∈ {ℐ}^{TG}} [ {π}_{SCo {ω}_{k}}^{CY} {y}_{STtk {ω}_{k}}^{TG} + {π}_{VCt {ω}_{k}}^{TG} ( {x}_{RAtk {ω}_{k}}^{TG} ) {y}_{SDtk {ω}_{k}}^{TG} ] \} \qquad \begin{matrix}( 21 a ) \\ \\ \\ ( 21 b ) \\ \\ \\ ( 21 c )\end{matrix}$$

The term in (21a) represents total mileage cost, the term in (21b) represents total stop fe, and the term in (21c) represents total production cost. Total production cost consists of a fixed or start-up cost (i.e., first term in (21c)) and a variable cost based on the produced radioactivity (i.e. second term in (21c)).

Toll-way fees are implicitly included in the proposed model via the network branches and their associated costs. For example, two branches may be added between two nodes, one with toll-way fee, and the other without a toll-fee.

The main variable-cost of a production inventory is the cost of ¹⁸O radionuclide. The cyclotron is associated with a set-up cost (to be included in the cost of a batch), and the distribution costs are: stop fees, mileage costs, fuel surcharges, and toll way fees. Internal vehicle costs will be calculated via the above parameters and represented as a courier. Internal vehicles are to be assigned before external vehicles. The stop fee is a contractual fixed cost, per customer, per delivery location. The mileage cost is a linear function determined by the associated rate and actual distance travelled. The mileage rate is determined by the courier and stated in the contract. Given a route, the actual distance travelled by a delivery vehicle is a random variable, which may be assumed as an average value based on previous data. The fuel surcharge depends on the cost of gasoline, and is determined by the prevailing national rate. The stop fee is a fixed cost per customer location per stop. The toll-way fee is a fixed cost per toll way.

Accordingly, at S350, values of each discrete and continuous variable of the objective function are determined so as to minimize the objective function, based on given (i.e., known) parameter values. The determined variable values constitute variables of a production plan and a delivery schedule.

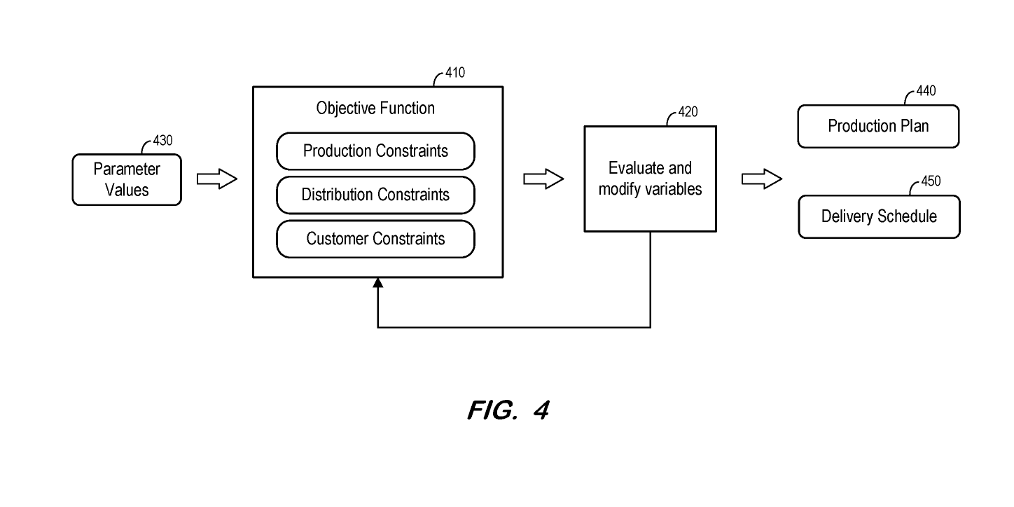

FIG. 4 is a functional block diagram illustrating S350 according to some embodiments. As shown, objective function 410 includes production constraints, distribution constraints and customer constraints. Each of the constraints is formulated as a combination or parameter values, continuous variables and discrete variables. In order to minimize objective function (and thereby determine those variable values which result in a minimized function), minimization module 420 evaluates objective function 410 using known parameter values 430 and initial values of the continuous and discrete variables of the production constraints, distribution constraints and customer constraints.

Next, as shown in FIG. 4, module 420 modifies the variable values based on the evaluation of objective function 410 and re-evaluates objective function 410 based on the modified variables. This process continues until module 420 determines that objective function 410 has been sufficiently minimized. The current values of the discrete and continuous variables are then used to generate production plan 440 and delivery schedule 450.

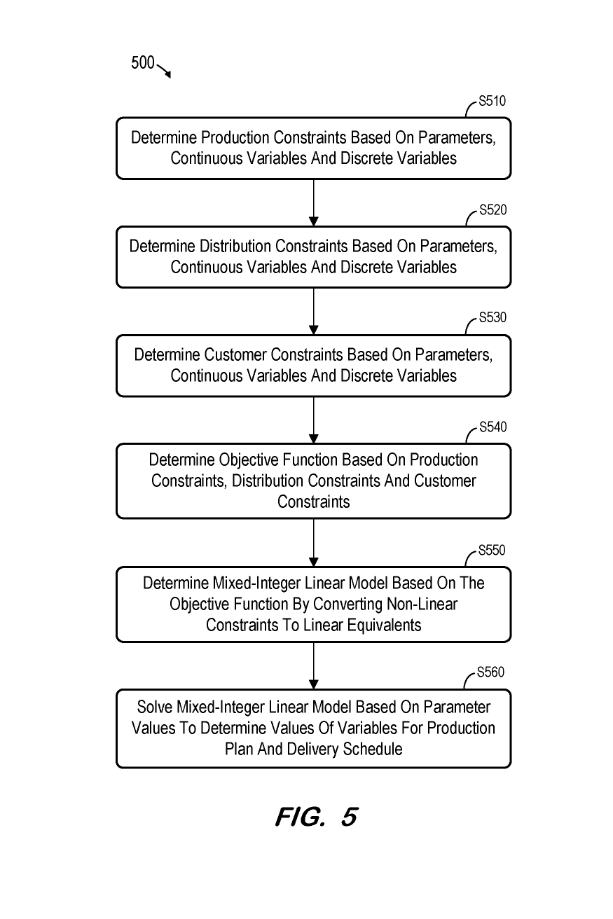

Systems for implementing the minimization operation of module 420 are known in the art. Such systems may present significant computational complexity. Accordingly, process 500 of FIG. 5 provides a system to minimize the objective function and determine corresponding variable values in a more computationally-efficient manner.

Steps S510 through S540 may proceed similarly to steps S310 through S340 of process 300, and descriptions thereof will therefore not be repeated. At S550, however, a mixed-integer linear model is determined based on the objective function. Determination of the mixed-integer linear model may comprise conversion of nonlinear constraints such as the minimum uptime and and downtime constraints, and the maximum and minimum radioactivity output constraints, into multi-stage stochastic mixed-integer linear constraints. Moreover, the nonlinear startup cost constraint is discretized into a linear function of the offline time of a target. A linear off-time counter is derived as a byproduct. Nonconvex variable cost functions are also expressed as piecewise mixed-integer linear functions.

In order to linearize product terms, every monomial whose total degree with respect to continuous variables is less than or equal to one is replaced with a set of mixed-integer linear equality or inequality constraints. For example, let x and y be continuous scalar variables, u, v and w be binary scalar variables, and i, j, k, m, and n be nonnegative integers. The total degree with respect to continuous variables of the monomial xⁱy^{j}u^{k}v^{m}wⁿ is equal to i+j.

For example, the mixed-integer constraint z=xy, where x is a bounded continuous variable and y is a binary variable, is equivalent to the following mixed-integer linear constraints:

yx≤z≤yx̅, (22a)

(1−y)x≤x−z≤(1−y)x̅. (22b)

Constraint (22a) ensures that z is zero if y is zero. Constraint (22b) ensures that z is equal to x if y is 1. The mixed-integer constraint z=xy, where both x and y are binary variable, is equivalent to the following mixed-integer linear constraints:

z≤x, (23a)

z≤y, (23b)

z≥x+y−1. (23c)

Constraints (23a) and (23b) ensure that z is zero if x is zero or y is zero. Constraint (23c) ensures that z is equal to 1 if both x and y are zero.

The mixed-integer constraints (11) may be converted nto the following equivalent mixed-integer linear form:

$$\begin{matrix}{\sum }_{k = 1}^{{\tilde{π}}_{UT t {ω}_{k}}^{TG}} [ 1 - {y}_{ONtk {ω}_{k}}^{TG} ] = 0 & ( 24 a ) \\ {\sum }_{τ = k}^{k + {π}_{UTt {ω}_{k}}^{TG} - 1} {y}_{ONt τ {ω}_{k}}^{TG} \geq {π}_{UT t {ω}_{k}}^{TG} {y}_{STtk {ω}_{k}}^{TG} , \\ k = {\tilde{π}}_{UTt {ω}_{k}}^{TG} + 1 , … , \vert {𝒥}^{TM} \vert - {π}_{UTt {ω}_{k}}^{TG} + 1 & ( 24 b ) \\ {\sum }_{τ = k}^{\vert {𝒥}^{TM} \vert} [ {y}_{ONt τ {ω}_{k}}^{TG} - {y}_{STtk {ω}_{k}}^{TG} ] \geq 0 , \\ k = \vert {𝒥}^{TM} \vert - {π}_{UTt {ω}_{k}}^{TG} + 2 , … , \vert {𝒥}^{TM} \vert & ( 24 c ) \\ where & \\ {\tilde{π}}_{UTt {ω}_{k}}^{TG} = min \{ \vert {𝒥}^{TM} \vert , ( {π}_{UTt {ω}_{k}}^{TG} - {x}_{ONt 0 {ω}_{k}}^{TG} ) {y}_{ONt 0 {ω}_{k}}^{TG} \} \cdot & \\ {\sum }_{k = 1}^{{\tilde{π}}_{DTt {ω}_{k}}^{TG}} {y}_{ONtk {ω}_{k}}^{TG} = 0 & ( 25 a ) \\ {\sum }_{τ = k}^{k + {π}_{DTt {ω}_{k}}^{TG} - 1} [ 1 - {y}_{ONt τ {ω}_{k}}^{TG} ] \geq {π}_{DTt {ω}_{k}}^{TG} {y}_{SDtk {ω}_{k}}^{TG} , \\ k = {\tilde{π}}_{DTt {ω}_{k}}^{TG} + 1 , … , \vert {𝒥}^{TM} \vert - {π}_{DTt {ω}_{k}}^{TG} + 1 & ( 25 b ) \\ \begin{matrix} {\sum }_{τ = k}^{\vert {𝒥}^{TM} \vert} [ 1 - {y}_{ONt τ {ω}_{k}}^{TG} - {y}_{SDtk {ω}_{k}}^{TG} ] \geq 0 , \\ k = \vert {𝒥}^{TM} \vert - {π}_{DTt {ω}_{k}}^{TG} + 2 , … , \vert {𝒥}^{TM} \vert \\ where \\ {\tilde{π}}_{DTt {ω}_{k}}^{TG} = min \{ \vert {𝒥}^{TM} \vert , ( {π}_{DTt {ω}_{k}}^{TG} - {x}_{OFt 0 {ω}_{k}}^{TG} ) ( 1 - {y}_{ONt 0 {ω}_{k}}^{TG} ) \} .\end{matrix} & ( 25 c )\end{matrix}$$

Constraint (24a) enforces the minimum uptime constraints for every target t that has been online at period 0 for a time period not exceeding their minimum up time. Constraint (24b) enforces the minimum uptime logic for all sets of consecutive periods of size π_{UTtω}_{ₖ}^{TG}. Constraints (24c) enforces the minimum up time logic for the last π_{UTtω}_{ₖ}^{TG}−1 periods; that is, if target t is started in one of these hours it must remain on-line till the end of the scheduling horizon. Constraints (25a)-(25c), which enforce the minimum downtime logic, are derived from (24a)-(24c) by substitution of 1−y_{ONtkω}_{ₖ}^{TG}, y_{STtkω}_{ₖ}^{TG}, π_{UTtω}_{ₖ}^{TG} and x_{ONt0ω}_{ₖ}^{TG} for y_{ONtkω}_{ₖ}^{TG}, y_{DTtkω}_{ₖ}^{TG}, π_{DTtω}_{ₖ}^{TG} and x_{OFt0ω}_{ₖ}^{TG} respectively.

With respect to radioactivity production and decay, the following mixed-integer linear approximation may be used to support occasional cases in which a variable beam current may be applied to target:

x_{RAt(k-1)ω}_{ₖ}^{TG}−x_{RAtkω}_{ₖ}^{TG}≤π_{RDtω}_{ₖ}^{TG}(1−y_{ONtkω}_{ₖ}^{TG})+π_{REtω}_{ₖ}^{TG}y_{ONtkω}_{ₖ}^{TG}, ∀t ∈ [symbol] ^{TG}, ∀k ∈ [symbol] ^{TM}, (26a)

x_{RAtkω}_{ₖ}^{TG}−x_{RAt(k-1)ω}_{ₖ}^{TG}≤π_{RUtω}_{ₖ}^{TG}(1−y_{STtkω}_{ₖ}^{TG})+π_{RStω}_{ₖ}^{TG}y_{STtkω}_{ₖ}^{TG}, ∀t ∈ [symbol] ^{TG}, ∀k ∈ [symbol] ^{TM} (26b)

x_{RAtkω}_{ₖ}^{TG}≥0, ∀t ∈ [symbol] ^{TG}, ∀k ∈ [symbol] ^{TM} (26c)

The following miscellaneous production constraints enforce the feasibility of the offline and online states, and state transitions (e.g. a target may not online and offline at the same time).

y_{STtkω}_{ₖ}^{TG}−y_{SDtkω}_{ₖ}^{TG}−y_{ONtkω}_{ₖ}^{TG}+y_{ONt(k-1)ω}_{ₖ}^{TG}=0, ∀t ∈ [symbol] ^{TG}, ∀k ∈ [symbol] ^{TM}, (27a)

y_{STtkω}_{ₖ}^{TG}+y_{SDtkω}_{ₖ}^{TG}−1≤0, ∀t ∈ [symbol] ^{TG}, ∀k ∈ [symbol] ^{TM}. (27b)

The following constraints define the number of time increments that a target has been online:

x_{ONtkω}_{ₖ}^{TG}≤x_{ONt(k-1)ω}_{ₖ}+1, (28a)

x_{ONtkω}_{ₖ}^{TG}+(x̅_{ONtkω}_{ₖ}1)(1−y_{ONtkω}_{ₖ}^{TG})≥x_{ONt(k-1)ω}_{ₖ}^{TG}+1, (28b)

x_{ONtkω}_{ₖ}−x̅_{ONtkω}_{ₖ}^{TG}y_{ONtkω}_{ₖ}^{TG}≤0, (28c)

x_{ONtkω}_{ₖ}^{TG}≥0, (28d)

Constraints (28) define that the online time counter, of a target t at time k, is incremented by 1 if target t is online at time k; otherwise the said time counter is set to zero.

The following constraints define the number of time increments that a target has been offline:

x_{OFtkω}_{ₖ}^{TG}≤x_{OFt(k-1)ω}_{ₖ}^{TG}+1, (29a)

x_{OFtkω}_{ₖ}^{TG}+(x̅_{OFtkω}_{ₖ}^{TG}+1)y_{OFtkω}_{ₖ}^{TG}≥x_{OFt(k-1)ω}_{ₖ}^{TG}+1, (29b)

x_{OFtkω}_{ₖ}^{TG}−x̅_{OFtkω}_{ₖ}^{TG}(1−y_{OFtkω}_{ₖ}^{TG})≤0, (29c)

x_{OFtkω}_{ₖ}^{TG}≥0, (29d)

Constraints (29) define that the offline time counter, of a target t at time k, is incremented by 1 if target t is offline at time k; otherwise the said time counter is set to zero.

The mixed-integer linear model is solved at S560. The solving is performed based on known parameter values to determine values of the constraint variables which result in a minimized (i.e., minimized to an acceptable degree) mixed-integer linear model. The variables are then used to determine a production plan and a delivery schedule as described above. Advantageously, an instance of the mixed-integer linear model's linear relaxation can be solved using a stochastic dual dynamic programming method provided by commercial solvers (e.g. CPLEX, Gurobi). Such solvers may leverage the sparse structure of the mixed-integer linear model to provide more-efficient computation than would otherwise be possible.

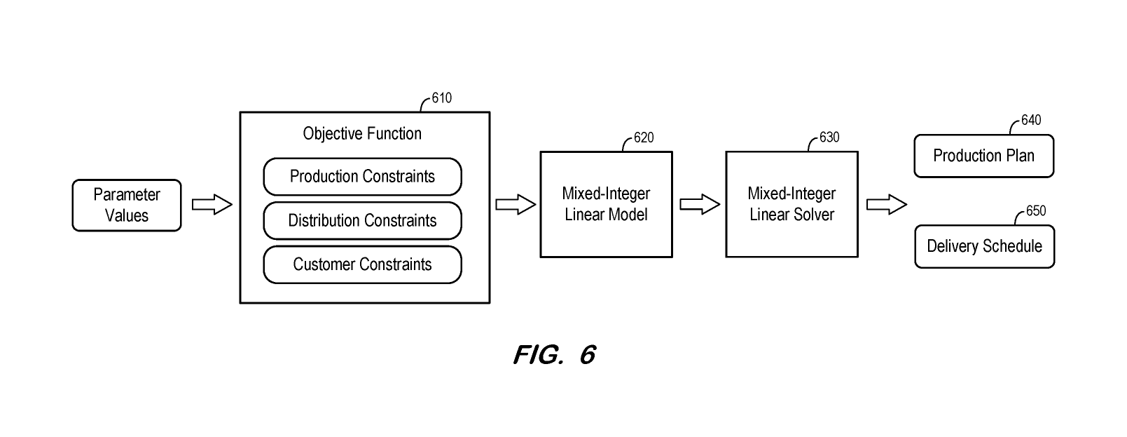

FIG. 6 is a functional block diagram illustrating process 500 according to some embodiments. As shown, objective function 610 includes production constraints, distribution constraints and customer constraints. Mixed-integer linear model 620 is generated based on objective function 610 at S550 and is input to solver 630 at S560. Solver 630 then determines the values of the discrete and continuous variables of mixed-integer linear model 620 which minimize production and delivery costs. These values are then used to generate production plan 640 and delivery schedule 650.

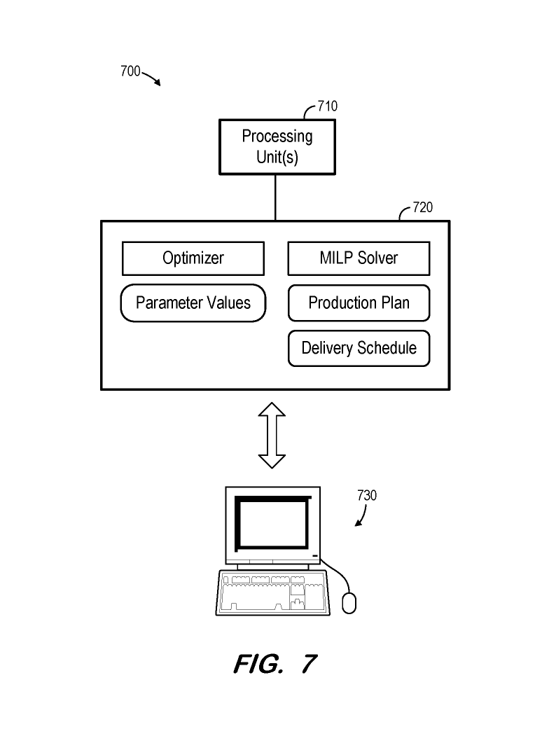

FIG. 7 illustrates system 700 according to some embodiments. System 700 may execute any of the processes described herein according to some embodiments. System 700 comprises processing unit(s) 710 and storage device 720, each of which may comprise any processing unit to execute processor-executable program code and any system for storing electronic data that is or becomes known.

Storage device 720 stores processor-executable program code of an optimizer. The optimizer may be executed to determine a delivery schedule and a production plan based on parameter values as described herein. The determination is based on the aforementioned production constraints, distribution constraints, customer constraints, and objective function. The parameter values may be stored in storage device 720 as shown and/or may be received from another computing device or from terminal 730 of system 700.

Determination of the production plan and the delivery schedule may be based on a mixed-integer linear model as described above with respect to process 500. In such a case, the optimizer may utilize processor-executable program code of a MILP solver also stored in storage device 720.

System 700 may comprise any combination of computing hardware that is or becomes known. In some embodiments, system 700 is a desktop computing system which performs all of the determinations described herein. In other embodiments, system 700 comprises a client-server architecture in which terminal 730 primarily functions as a user interface renderer and the determinations are performed by a remote server. System 700 may include other elements which are necessary for the operation thereof, as well as additional elements for providing functions other than those described herein.).

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A system comprising:
a cyclotron to bombard a target comprising a first material with a beam of protons to produce a second material;
a chemistry module system to synthesize the second material to a positron emission tomography radioactive tracer;
a dose dispensing system to prepare doses of the positron emission tomography radioactive tracer;
an input device to receive parameter values from an operator; and
a processor to:
determine an objective function representing costs of creating the doses and delivering the doses to customers, the objective function being subject to production constraints, delivery constraints and customer constraints, where the production constraints, delivery constraints and customer constraints are defined by discrete variables, continuous variables and parameter values;
receive the parameter values from the input device;
generate a solution to the objective function based on the received parameter values to determine values of the discrete variables and the continuous variables which correspond to suitable costs of creating the doses and delivering the doses to customers; and
generate a positron emission tomography radioactive tracer production plan and a delivery schedule based on the values of the discrete variables and the continuous variables.

2. A system according to claim 1, the processor further to:
convert the objective function to a mixed-integer linear model.

3. A system according to claim 2, wherein conversion of the objective function to a mixed-integer linear model comprises converting nonlinear constraints of the objective function into multi-stage stochastic mixed-integer linear constraints.

4. A system according to claim 2, wherein generation of a solution to the objective function comprises input of the mixed-integer linear model to a mixed-integer linear programming solver application.

5. A system according to claim 2, wherein generation of a solution to the objective function is based on a sparse structure of the mixed-integer linear model.

6. A system according to claim 2, wherein the production constraints comprise a duration of bombardment, an uptime of the cyclotron, a downtime of the cyclotron, a radioactivity of the first material, an unload time of the target, a load time of the target, a preparation time of the chemistry module system, a synthesis time, a percent yield, and a radioactivity of the positron emission tomography radioactive tracer at an end of synthesis.

7. A system according to claim 6, wherein the customer constraints comprise a delivery time period, a customer-ordered radioactivity at delivery time, and a total radioactivity of non-injected doses at a customer site.

8. A system according to claim 1, wherein the production constraints comprise a duration of bombardment, an uptime of the cyclotron, a downtime of the cyclotron, a radioactivity of the first material, an unload time of the target, a load time of the target, a preparation time of the chemistry module system, a synthesis time, a percent yield, and a radioactivity of the positron emission tomography radioactive tracer at an end of synthesis, and
wherein the customer constraints comprise a delivery time period, a customer-ordered radioactivity at delivery time, and a total radioactivity of non-injected doses at a customer site.

9. A system comprising:
a memory storing processor-executable process steps; and
a processing unit to execute the processor-executable process steps to:
determine an objective function representing costs of creating doses of a positron emission tomography radioactive tracer and delivering the doses to customers, the objective function being subject to production constraints associated with one or more cyclotrons, delivery constraints and customer constraints, where the production constraints, delivery constraints and customer constraints are defined by discrete variables, continuous variables and parameter values;
receive a set of parameter values;
generate a solution to the objective function based on received set of parameter values to determine values of the discrete variables and the continuous variables which correspond to suitable costs of creating the doses and delivering the doses to customers; and
generate a positron emission tomography radioactive tracer production plan and a delivery schedule based on the values of the discrete variables and the continuous variables.

10. A system according to claim 9, the processing unit to further execute the processor-executable process steps to:
convert the objective function to a mixed-integer linear model.

11. A system according to claim 10, wherein conversion of the objective function to a mixed-integer linear model comprises converting nonlinear constraints of the objective function into multi-stage stochastic mixed-integer linear constraints.

12. A system according to claim 10, wherein generation of a solution to the objective function comprises input of the mixed-integer linear model to a mixed-integer linear programming solver application.

13. A system according to claim 10, wherein generation of a solution to the objective function is based on a sparse structure of the mixed-integer linear model.

14. A system according to claim 2, wherein the production constraints comprise a duration of bombardment of a target by the cyclotron, an uptime of the cyclotron, a downtime of the cyclotron, a radioactivity of the target, an unload time of the target, a load time of the target, a preparation time of a chemistry module system to synthesize the bombarded target into the positron emission tomography radioactive tracer, a synthesis time, a percent yield, and a radioactivity of the positron emission tomography radioactive tracer at an end of synthesis,
and wherein the customer constraints comprise a delivery time period, a customer-ordered radioactivity at delivery time, and a total radioactivity of non-injected doses at a customer site.

15. A computer-implemented method comprising:
determining an objective function representing costs of creating doses of a positron emission tomography radioactive tracer and delivering the doses to customers, the objective function being subject to production constraints associated with one or more cyclotrons, delivery constraints and customer constraints, where the production constraints, delivery constraints and customer constraints are defined by discrete variables, continuous variables and parameter values;
receiving a set of parameter values;
generating a solution to the objective function based on received set of parameter values to determine values of the discrete variables and the continuous variables which correspond to suitable costs of creating the doses and delivering the doses to customers; and
generating a positron emission tomography radioactive tracer production plan and a delivery schedule based on the values of the discrete variables and the continuous variables.

16. A method according to claim 15, further comprising:
converting the objective function to a mixed-integer linear model.

17. A method according to claim 16, wherein converting the objective function to a mixed-integer linear model comprises converting nonlinear constraints of the objective function into multi-stage stochastic mixed-integer linear constraints.

18. A system according to claim 17, wherein generating the solution to the objective function is based on a sparse structure of the mixed-integer linear model.

19. A system according to claim 17, wherein the production constraints comprise a duration of bombardment of a target by the cyclotron, an uptime of the cyclotron, a downtime of the cyclotron, a radioactivity of the target, an unload time of the target, a load time of the target, a preparation time of a chemistry module system to synthesize the bombarded target into the positron emission tomography radioactive tracer, a synthesis time, a percent yield, and a radioactivity of the positron emission tomography radioactive tracer at an end of synthesis,
and wherein the customer constraints comprise a delivery time period, a customer-ordered radioactivity at delivery time, and a total radioactivity of non-injected doses at a customer site.

20. A system according to claim 15, wherein the production constraints comprise a duration of bombardment of a target by the cyclotron, an uptime of the cyclotron, a downtime of the cyclotron, a radioactivity of the target, an unload time of the target, a load time of the target, a preparation time of a chemistry module system to synthesize the bombarded target into the positron emission tomography radioactive tracer, a synthesis time, a percent yield, and a radioactivity of the positron emission tomography radioactive tracer at an end of synthesis,
and wherein the customer constraints comprise a delivery time period, a customer-ordered radioactivity at delivery time, and a total radioactivity of non-injected doses at a customer site.
